(19) United States
(12) Patent Application Publication
(10) Pub. No.: US 2025/0232921 A1
(43) Pub. Date: Jul. 17, 2025

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventors: Kunihiko NAGAOKA, Tokyo (JP); Tomomi MACHIDA, Tokyo (JP); Kazuyuki KOIDE, Tokyo (JP); Eriko NUMATA, Tokyo (JP)

(73) Assignee: TAIYO YUDEN CO., LTD., Tokyo (JP)

(21) Appl. No.: 19/005,120

(22) Filed: Dec. 30, 2024

(30) Foreign Application Priority Data
Jan. 16, 2024 (JP) 2024-004800
Jan. 16, 2024 (JP) 2024-004815

(51) Int. Cl. H01G 4/30; H01G 4/008; H01G 4/012; H01G 4/12

(52) U.S. Cl. CPC H01G 4/30; H01G 4/008; H01G 4/012; H01G 4/1209

(57) ABSTRACT

A multilayer ceramic electronic device includes a multilayer body having a rectangular parallelepiped shape in which a plurality of first dielectric layers, a plurality of second dielectric layers, and a plurality of internal electrode layers are stacked. Each average thickness of each of the plurality of first dielectric layers is different from that of each of the plurality of second dielectric layers. Each of the plurality of first dielectric layers and each of the plurality of second dielectric layers are alternately stacked through each of the plurality of internal electrode layers.

### CROSS-REFERENCE TO RELATED APPLICATION

This application is based upon and claims the benefit of priority of the prior Japanese Patent Application No. 2024-004800, filed on Jan. 16, 2024 and the prior Japanese Patent Application No. 2024-004815, filed on Jan. 16, 2024, the entire contents of which are incorporated herein by reference.

### FIELD

A certain aspect of the present disclosure relates to a multilayer ceramic electronic device and a manufacturing method of the multilayer ceramic electronic device.

### BACKGROUND

In response to the demand for higher capacity for multilayer ceramic electronic components such as multilayer ceramic capacitors, the dielectric layers between the internal electrodes in the ceramic body are becoming thinner so that the number of layers can be increased (see, for example, Japanese Patent Application Publication No. JP 2019-9290).

### SUMMARY OF THE INVENTION

According to an aspect of the embodiments, there is provided a ceramic electronic device including: a multilayer body having a rectangular parallelepiped shape in which a plurality of first dielectric layers, a plurality of second dielectric layers, and a plurality of internal electrode layers are stacked, wherein each average thickness of each of the plurality of first dielectric layers is different from that of each of the plurality of second dielectric layers, and wherein each of the plurality of first dielectric layers and each of the plurality of second dielectric layers are alternately stacked through each of the plurality of internal electrode layers.

According to another aspect of the embodiments, there is provided a manufacturing method of a multilayer ceramic electronic device including: forming each of a plurality of first green sheets by applying a ceramic slurry on each of base materials; forming each of a plurality of first internal electrode patterns on each of the first green sheets; forming each of a plurality of second green sheets by applying a ceramic slurry on each of the plurality of first green sheets and each of the plurality of first internal electrode patterns so that each average thickness of each of the plurality of second green sheets is different from each average thickness of each of the plurality of first green sheets; forming each of a plurality of second internal electrode patterns on each of the plurality of second green sheets; peeling the plurality of first green sheets and the plurality of second green sheets from the base materials; stacking and crimping a plurality of sets of the plurality of first green sheets and the plurality of second green sheets; dividing the plurality of sets of the plurality of first green sheets and the plurality of second green sheets after the crimping into a plurality of multilayer bodies by cutting the plurality of sets of the plurality of first green sheets and the plurality of second green sheets along a stacking direction; and firing the plurality of multilayer bodies.

According to another aspect of the embodiments, there is provided a manufacturing method of a multilayer ceramic electronic device including: forming each of a plurality of first green sheets by applying a ceramic slurry on each of base materials; forming each of a plurality of first internal electrode patterns on each of the first green sheets; forming each of a plurality of second green sheets by applying a ceramic slurry on each of the plurality of first green sheets and each of the plurality of first internal electrode patterns so that each average thickness of each of the plurality of second green sheets is different from each average thickness of each of the plurality of first green sheets; forming each of a plurality of second internal electrode patterns on each of the plurality of second green sheets; forming each of a plurality of third green sheets by applying a ceramic slurry on each of the plurality of second green sheets and each of the plurality of second internal electrode patterns so that each average thickness of each of the plurality of third green sheets is different from each average thickness of each of the plurality of first green sheets and each average thickness of each of the plurality of second green sheets; forming each of a plurality of third internal electrode patterns on each of the plurality of third green sheets; peeling the plurality of first green sheets, the plurality of second green sheets and the plurality of third green sheets from the base materials; stacking and crimping a plurality of sets of the plurality of first green sheets, the plurality of second green sheets and the plurality of third green sheets; dividing the plurality of sets of the plurality of first green sheets, the plurality of second green sheets and the plurality of third green sheets after the crimping into a plurality of multilayer bodies by cutting the plurality of sets of the plurality of first green sheets, the plurality of second green sheets and the plurality of third green sheets along a stacking direction; and firing the plurality of multilayer bodies.

### BRIEF DESCRIPTION OF THE DRAWINGS

FIG. 1 is a perspective view of an example of a multilayer ceramic capacitor;

FIG. 2 is a cross-sectional view of a multilayer ceramic capacitor taken along a line A-A in FIG. 1;

FIG. 3 is a cross-sectional view of a multilayer ceramic capacitor taken along a line B-B in FIG. 2;

FIG. 4 is a cross-sectional view of a multilayer ceramic capacitor taken along a line C-C in FIG. 2;

FIG. 5 is a cross-sectional view illustrating an example of a microstructure of section illustrated in FIG. 2;

FIG. 6 is a cross-sectional view of a multilayer ceramic capacitor of another embodiment taken along a line A-A in FIG. 1;

FIG. 7 is a flow chart illustrating an example of a manufacturing process of a multilayer ceramic capacitor;

FIG. 8 is a cross-sectional view illustrating an example of a stack sheet forming step;

FIG. 9 is a cross-sectional view illustrating an example of a stack sheet peeling step and a stacking and crimping step;

FIG. 10 is a cross-sectional view illustrating an example of a green sheet forming step and an internal electrode pattern forming step of another multilayer ceramic capacitor; and

FIG. 11 is a cross-sectional view illustrating an example of a stacking and crimping step in another embodiment.

### DETAILED DESCRIPTION

However, when forming a thin dielectric layer, not only is it difficult to peel the green sheet from the PET (Polyethylene Terephthalate) film of the base material without damaging the green sheet, but the rapid shrinkage of multiple dielectric layers during firing increases the difference in the amount of shrinkage between the margin of the dielectric adjacent to the periphery of the multilayer section of the dielectric layers and internal electrodes, making the ceramic body prone to cracks. This may reduce the reliability of the multilayer ceramic capacitor.

### Embodiment

### Structure of a Multilayer Ceramic Capacitor

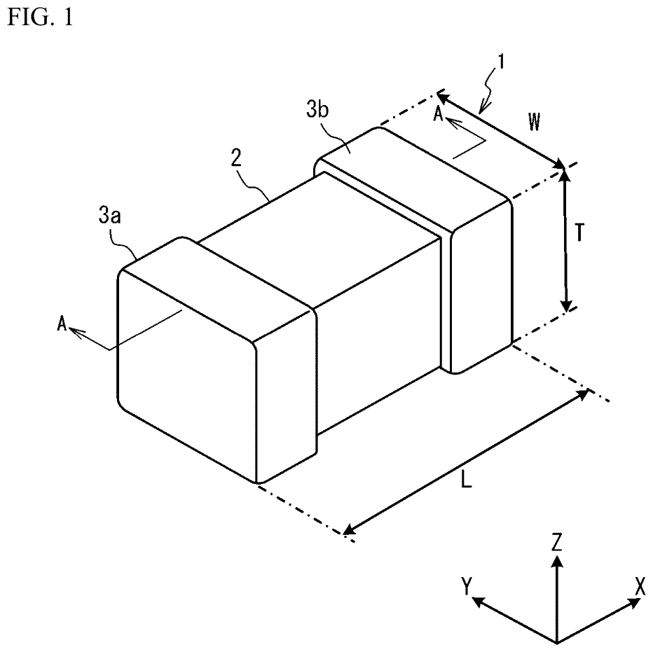

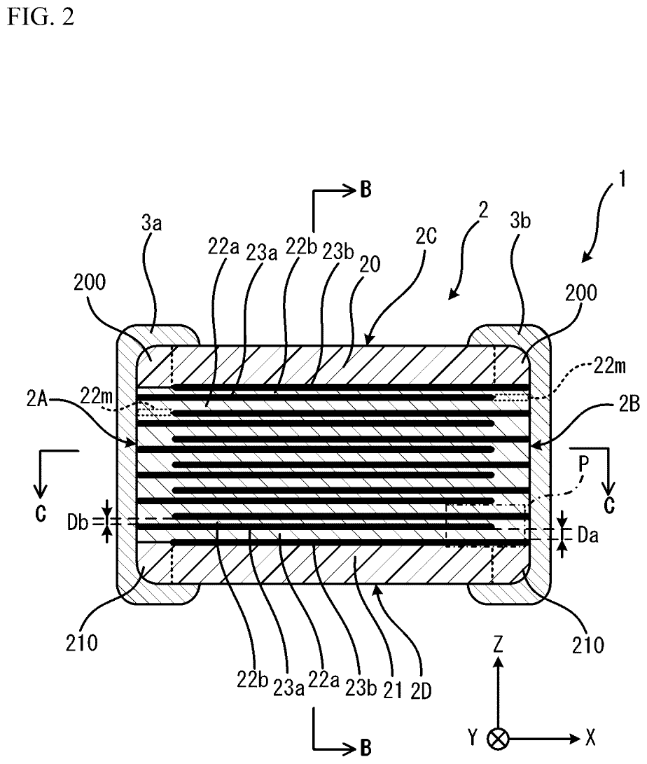

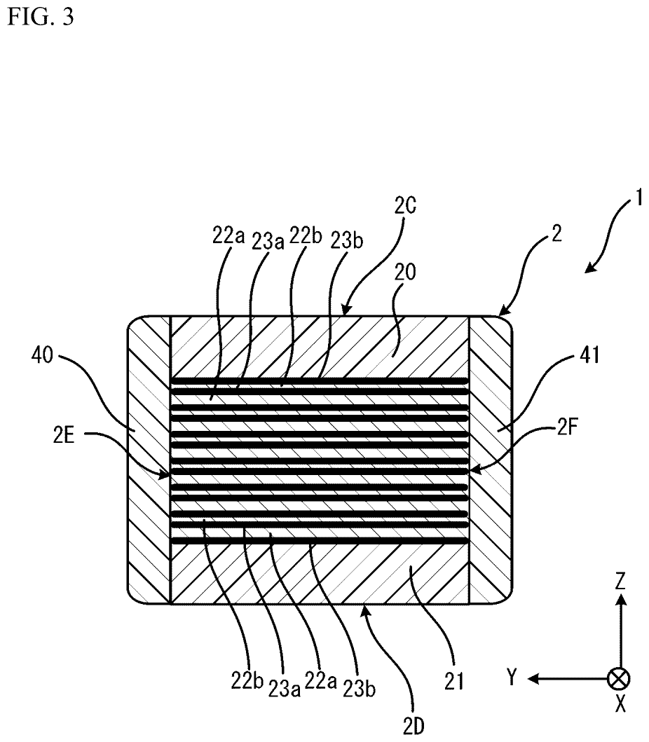

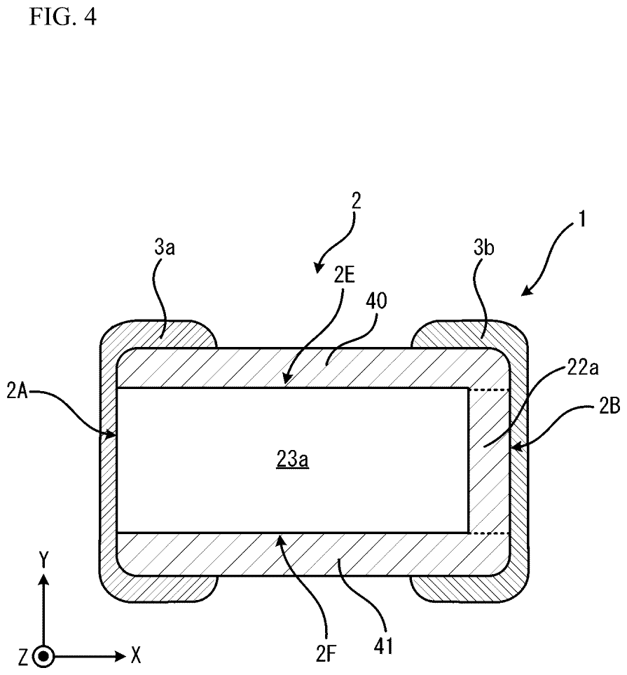

FIG. 1 is a perspective view of an example of a multilayer ceramic capacitor 1. FIG. 2 is a cross-sectional view of the multilayer ceramic capacitor 1 taken along a line A-A in FIG. 1. FIG. 3 is a cross-sectional view of the multilayer ceramic capacitor 1 taken along a line B-B in FIG. 2. FIG. 4 is a cross-sectional view of the multilayer ceramic capacitor 1 taken along a line C-C in FIG. 2.

The multilayer ceramic capacitor 1 has a multilayer body 2 having a substantially rectangular parallelepiped shape, and external electrodes 3a and 3b provided on a pair of end faces 2A and 2B of the multilayer body 2 that face each other. The multilayer ceramic capacitor 1 is an example of a multilayer ceramic electronic component. Other examples of multilayer ceramic electronic components include a multilayer ceramic varistor and a multilayer ceramic thermistor, and in this embodiment, the multilayer ceramic capacitor 1 is a representative example of these.

In FIG. 1 to FIG. 4, the X direction, the Y direction, and the Z direction, which are mutually orthogonal, are illustrated. The X direction is the length (L) direction of the multilayer ceramic capacitor 1, and corresponds to the direction in which the pair of end faces 2A and 2B of the multilayer body 2 face each other. The Y direction is the width (W) direction of the multilayer ceramic capacitor 1, and corresponds to the direction in which the pair of side faces 2E and 2F of the multilayer body 2 face each other. The Z direction is the height (T) direction of the multilayer ceramic capacitor 1, and corresponds to the direction in which the upper face 2C and the lower face 2D of the multilayer body 2 face each other and the stacking direction of the multilayer ceramic capacitor 1. The width direction is an example of a direction approximately perpendicular to the stacking direction of the multilayer body 2.

The multilayer body 2 has an upper face 2C, a lower face 2D, the pair of end faces 2A and 2B, and a pair of side faces 2E and 2F. The upper face 2C and the lower face 2D are approximately flat faces that face each other in the stacking direction. The pair of end faces 2A and 2B are approximately flat faces that face each other in the length direction. And the pair of side faces 2E and 2F are approximately flat faces that face each other in the width direction.

The multilayer body 2 has a multilayer structure in which dielectric layers 22a and 22b containing a ceramic material that functions as a dielectric and internal electrode layers 23a and 23b are alternately stacked, and further a pair of cover layers 20 and 21 are stacked so as to sandwich the dielectric layers 22a and 22b and the internal electrode layers 23a and 23b from both sides in the stacking direction. In the multilayer body 2, the portion sandwiched between the pair of internal electrode layers 23a and 23b adjacent to each of the dielectric layers 22a and 22b contributes to the electrostatic capacity of the multilayer ceramic capacitor 1 and is sometimes called the “capacity section layer”.

The cover layers 20 and 21 sandwich the capacity section layer from both sides in the stacking direction. Edge portions 200 and 210 having curved surfaces are formed on both ends of the cover layers 20 and 21 in the length direction, respectively.

The multilayer body 2 also has side margins 40 and 41 that cover each of the side faces 2E and 2F. The side margins 40 and 41 extend along the length direction and sandwich the multilayer section of the internal electrode layers 23a and 23b and the dielectric layers 22a and 22b, i.e., the capacity section layer, from both sides in the width direction. The side margins 40 and 41 are mainly composed of the same ceramic material as the dielectric layers 22a and 22b.

The internal electrode layers 23a and 23b have a substantially rectangular shape when viewed from the front in the stacking direction, and face each other in the stacking direction with the dielectric layers 22a and 22b in between. The internal electrode layers 23a and 23b are alternately arranged along the stacking direction. A first end of the internal electrode layer 23a is drawn out to the end face 2A and connected to the external electrode 3a, and a second end of the internal electrode layer 23b is drawn out to the end face 2B and connected to the external electrode 3b. The average thickness of the internal electrode layers 23a and 23b is substantially the same.

The internal electrode layers 23a and 23b are mainly composed of base metals such as Ni (nickel), Cu (copper), or Sn (tin). Noble metals such as Pt (platinum), Pd (palladium), Ag (silver), or Au (gold), or alloys containing these, may also be used as the internal electrode layers 23a and 23b. The thickness of the internal electrode layers 23a and 23b is, for example, 0.05 μm or more and 0.6 μm or less.

The dielectric layers 22a, 22b have a main phase of a ceramic material having a perovskite structure represented by the general formula ABO₃. The perovskite structure includes ABO_{3-α}, which is out of the stoichiometric composition (α indicates a small number). For example, the ceramic material can be selected from at least one of BaTiO₃ (barium titanate), CaZrO₃ (calcium zirconate), CaTiO₃ (calcium titanate), SrTiO₃ (strontium titanate), MgTiO₃ (magnesium titanate), and Ba_{1-x-y}CaₓSr_{y}Ti_{1-z}Zr₂O₃ (0≤x≤1, 0≤y≤1, 0≤z≤1) that form a perovskite structure. Ba_{1-x-y}CaₓSr_{y}Ti_{1-z}Zr₂O₃ is barium strontium titanate, barium calcium titanate, barium zirconate, barium titanate zirconate, calcium titanate zirconate, and barium calcium titanate zirconate.

The dielectric layers 22a and 22b are alternately stacked with the internal electrode layers 23a and 23b interposed between them. Each of the dielectric layers 22a and 22b is sandwiched between the internal electrode layers 23a and 23b from above and below in the stacking direction. The dielectric layer 22a is an example of a first dielectric layer, and the dielectric layer 22b is an example of a second dielectric layer.

The dielectric layers 22a and 22b have different average thicknesses Da and Db respectively. In this embodiment, the average thickness Da of the dielectric layer 22a is greater than the average thickness Db of the dielectric layer 22a. Here, the average thicknesses Da and Db refer to the average values of thicknesses along the stacking direction in the XY plane.

In this way, in the multilayer body 2, the dielectric layers 22a with the large average thickness Da and the dielectric layers 22b with the small average thickness Db are alternately stacked in the stacking direction. Therefore, in the manufacturing of the multilayer ceramic capacitor 1, when the multilayer body 2 is sintered, a difference in the sinterability of each of the dielectric layers 22a and 22b can be provided. Specifically, due to the difference in the average thicknesses Da and Db, for example, the shrinkage amount and shrinkage timing of the dielectric layers 22a and 22b during sintering differ, and the difference in the shrinkage amount between the multilayer body 2 and the dielectric sections such as the side margins 40 and 41 and the cover layers 20 and 21 adjacent to the periphery of the multilayer structure of the dielectric layers 22a and 22b and the internal electrode layers 23a and 23b is reduced.

For this reason, compared to the case where the average thicknesses Da and Db are the same, the stress due to the shrinkage of each of the dielectric layers 22a and 22b can be dispersed. This suppresses the occurrence of cracks in the multilayer body 2 and improves the reliability of the multilayer ceramic capacitor 1.

To suppress the occurrence of cracks, it is preferable that the average thickness Da of the dielectric layer 22a is 1.05 to 2.0 times the average thickness Db of the dielectric layer 22b. More preferably, the average thickness Da of the dielectric layer 22a may be 1.1 to 1.3 times the average thickness Db of the dielectric layer 22b.

To suppress the occurrence of cracks more effectively, it is preferable that the average thickness Da of the dielectric layer 22a is 0.4 to 0.8 μm and the average thickness Db of the dielectric layer 22b is 0.3 to 0.7 μm. More preferably, the average thickness Da of the dielectric layer 22a may be 0.4 to 0.6 μm and the average thickness Db of the dielectric layer 22b may be 0.3 to 0.5 μm.

The average thicknesses Da and Db of each of the dielectric layers 22a and 22b are measured, for example, by adjusting the magnification of the scanning electron microscope or transmission electron microscope so that about three to four of the dielectric layers 22a and 22b are captured in one image, and measuring the thickness at ten equally spaced points for each layer.

### Grain Size of Ceramic Grains

The average grain size of the ceramic grains contained in each of the dielectric layers 22a and 22b may differ depending on the average thickness Da and Db of the dielectric layers 22a and 22b.

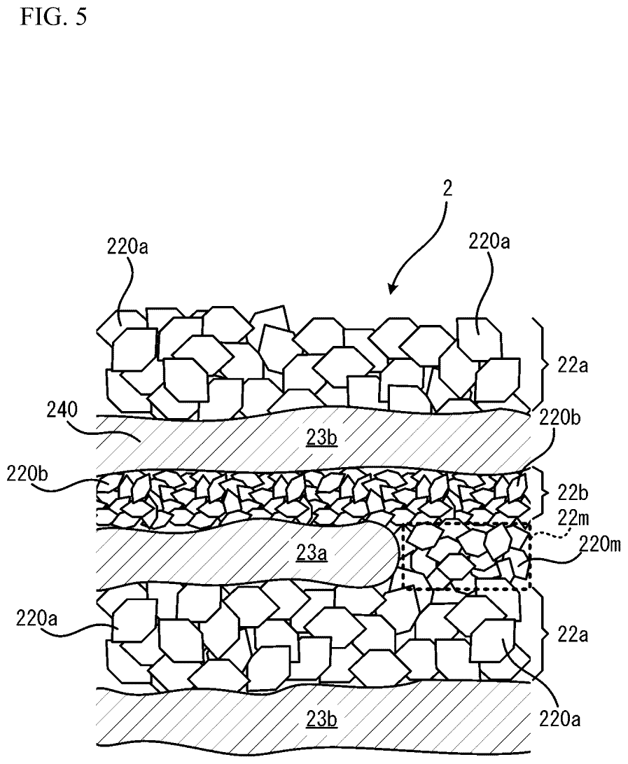

FIG. 5 is a cross-sectional view illustrating an example of the microstructure of section P illustrated in FIG. 2. The dielectric layer 22a is formed of a large number of ceramic grains 220a, the dielectric layer 22b is formed of a large number of ceramic grains 220b, and an end margin 22m is formed of a large number of ceramic grains 220m.

The average grain size of the ceramic grains 220a is larger than the average grain size of the ceramic grains 220b. In this way, of the dielectric layers 22a and 22b, the dielectric layer 22a with the larger average thickness contains ceramic grains 220a with a larger average grain size, and the dielectric layer 22b with the smaller average thickness contains ceramic grains 220b with a smaller average grain size.

Therefore, not only are the dielectric layers 22a and 22b appropriately smoothed according to their average thickness, but the size of the grain boundaries between the ceramic grains 220a and 220b is also appropriately adjusted according to the average thickness, thereby suppressing the movement of oxygen vacancies. As a result, the flatness and insulating properties of the dielectric layers 22a and 22b are improved compared to when the average grain size of the ceramic grains 220a and 220b is not set as described above.

To suppress the occurrence of cracks, it is preferable that the average grain size of the ceramic grains 220a is 1.15 to 2.0 times the average grain size of the ceramic grains 220b. More preferably, the average grain size of the ceramic grains 220a may be 1.4 to 1.65 times the average grain size of the ceramic grains 220b.

To suppress the occurrence of cracks, it is preferable that the average grain size of the ceramic grains 220a is 80 to 350 nm, and the average grain size of the ceramic grains 220b is 70 to 300 nm. More preferably, the average grain size of the ceramic grains 220a may be 80 to 150 nm, and the average grain size of the ceramic grains 220b may be 70 to 100 nm.

The average grain size of the ceramic grains 220m contained in the end margin 22m is 75 to 330 nm. This makes it possible to more effectively relieve stress and suppress the occurrence of cracks.

The average grain size of each of the ceramic grains 220a, 220b and 220m is measured, for example, by adjusting the magnification of a scanning electron microscope or a transmission electron microscope so that about 80 to 150 crystal grains are captured in one image, and measuring the Feret diameter of all crystal grains in the image. Here, the Feret diameter is the diameter in the direction parallel to the stacking direction of the multilayer ceramic capacitor 1.

### Inclusion of Rare Earth Elements

The dielectric layers 22a and 22b and the cover layers 20 and 21 are obtained, for example, by firing raw material powder of the main component ceramic having a perovskite structure. During firing, the raw material powder is exposed to a reducing atmosphere, which causes oxygen defects (oxygen vacancies) in the main component ceramic.

Therefore, the dielectric layers 22a and 22b and the cover layers 20 and 21 may contain at least one rare earth element that functions as a donor element by replacing the B site of the perovskite structure represented by ABO₃. Examples of rare earth elements that function as donor elements include, but are not limited to, Mo, Nb, Ta, and W. By adding a donor element to the dielectric layers 22a and 22b, the amount of oxygen vacancies generated and the amount of movement in the main component ceramic are suppressed, and the insulating characteristics are improved.

In this case, it is preferable that the concentration of the rare earth element in the main component ceramic of the dielectric layer 22b is higher than the concentration of the rare earth element in the main component ceramic of the dielectric layer 22a. For example, the amount of oxygen vacancies generated and the amount of movement are suppressed in the thin dielectric layer 22b more than in the thick dielectric layer 22a. Therefore, compared to a case where the concentrations of rare earth elements in the dielectric layers 22a and 22b are the same, the insulating characteristics of the multilayer ceramic capacitor 1 can be appropriately improved according to the average thicknesses of the dielectric layers 22a and 22b, thereby suppressing the occurrence of cracks and improving the insulating characteristics, thereby improving reliability.

In this case, in order to improve the reliability of the multilayer ceramic capacitor 1, the concentration of the rare earth element with respect to the ceramic that is the main component of the dielectric layer 22b is preferably 1.08 times or more the concentration of the rare earth element with respect to the ceramic that is the main component of the dielectric layer 22a. More preferably, the concentration of the rare earth element with respect to the ceramic that is the main component of the dielectric layer 22b may be 1.15 times or more the concentration of the rare earth element with respect to the ceramic that is the main component of the dielectric layer 22a.

In order to increase the electrostatic capacity of the multilayer ceramic capacitor 1, the concentration of the rare earth element with respect to the ceramic that is the main component of the dielectric layer 22b is preferably 1.7 times or less the concentration of the rare earth element with respect to the ceramic that is the main component of the dielectric layer 22a. More preferably, the concentration of the rare earth element with respect to the ceramic that is the main component of the dielectric layer 22b may be 1.5 times or less the concentration of the rare earth element with respect to the ceramic that is the main component of the dielectric layer 22a.

For example, it is preferable that the concentration of the rare earth element with respect to the ceramic that is the main component of the dielectric layer 22a is 0.5 to 2.0 at %, and the concentration of the rare earth element with respect to the ceramic that is the main component of the dielectric layer 22b is 0.7 to 2.2 at %.

Furthermore, the dielectric layers 22a and 22b and the cover layers 20 and 21 may each further contain magnesium (Mg) and manganese (Mn). This allows the dielectric layers 22a and 22b and the cover layers 20 and 21 to have improved insulation characteristics compared to when they do not contain magnesium and manganese.

At this time, in order to improve the reliability of the multilayer ceramic capacitor 1, it is preferable that the total concentration of the rare earth element, magnesium, and manganese with respect to the ceramic that is the main component of the dielectric layer 22b is 1.05 times or more the total concentration of the rare earth element, magnesium, and manganese with respect to the ceramic that is the main component of the dielectric layer 22a. More preferably, the total concentration of the rare earth element, magnesium, and manganese with respect to the ceramic that is the main component of the dielectric layer 22b is 1.2 times or more the total concentration of the rare earth element, magnesium, and manganese with respect to the ceramic that is the main component of the dielectric layer 22a.

To increase the electrostatic capacity of the multilayer ceramic capacitor 1, the total concentration of the rare earth element, magnesium, and manganese with respect to the ceramic that is the main component of the dielectric layer 22b is preferably 1.5 times or less the total concentration of the rare earth element, magnesium, and manganese with respect to the ceramic that is the main component of the dielectric layer 22a. More preferably, the total concentration of the rare earth element, magnesium, and manganese with respect to the ceramic that is the main component of the dielectric layer 22b is preferably 1.3 times or less the total concentration of the rare earth element, magnesium, and manganese with respect to the ceramic that is the main component of the dielectric layer 22a.

For example, it is preferable that the magnesium concentration with respect to the ceramic that is the main component of the dielectric layer 22a is 0 to 1.0 at %, and that the magnesium concentration with respect to the ceramic that is the main component of the dielectric layer 22b is 0.05 to 1.1 at %. For example, it is preferable that the manganese concentration with respect to the ceramic that is the main component of the dielectric layer 22a is 0 to 1.0 at %, and that the manganese concentration with respect to the ceramic that is the main component of the dielectric layer 22b is 0.05 to 1.1 at %.

### Another Embodiment of the Multilayer Ceramic Capacitor

The multilayer ceramic capacitor 1 described above has the multilayer body 2 in which two dielectric layers 22a and 22b with different average thicknesses are alternately stacked, but as in the following embodiment, the multilayer body 2 in which three dielectric layers are repeatedly stacked may also be used.

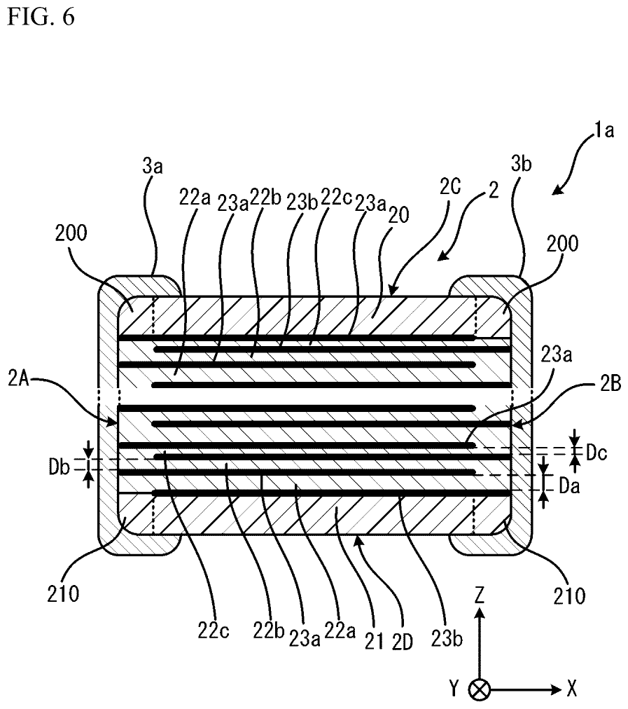

FIG. 6 is a cross-sectional view of a multilayer ceramic capacitor 1a of another embodiment taken along the line A-A in FIG. 1. In FIG. 6, the same components as those in FIG. 2 are given the same reference numerals, and the description thereof is omitted.

In addition to the above-mentioned dielectric layers 22a and 22b, the multilayer body 2 also includes a dielectric layer 22c having an average thickness Dc different from those of the dielectric layers 22a and 22b. The average thickness Dc of the dielectric layer 22c is smaller than the average thicknesses Da and Db of the dielectric layers 22a and 22b.

In the multilayer body 2, the dielectric layers 22a to 22c are repeatedly stacked in the stacking direction through the internal electrode layers 23a and 23b. As a result, the dielectric layer 22c is sandwiched between the internal electrode layers 23a and 23b from above and below in the stacking direction, and is stacked between the dielectric layers 22a and 22b. The dielectric layer 22c is mainly composed of the same ceramic material as the dielectric layers 22a and 22b. The dielectric layer 22c is an example of a third dielectric layer.

In this way, the multilayer body 2 has the three dielectric layers 22a to 22c with different average thicknesses Da to Dc repeatedly stacked in the stacking direction. Therefore, in the manufacturing of the multilayer ceramic capacitor 1, when the multilayer body 2 is sintered, a difference in sinterability can be provided for each of the dielectric layers 22a to 22c.

Specifically, due to the difference in the average thicknesses Da to Dc, for example, the shrinkage amount and shrinkage timing of the dielectric layers 22a to 22c during sintering differ, and the difference in shrinkage amount between the multilayer body 2 and the dielectric sections such as the side margins 40 and 41 and the cover layers 20 and 21 adjacent to the periphery of the stacked section of the dielectric layers 22a to 22c and the internal electrode layers 23a and 23b is further reduced.

Therefore, compared to the case where the average thicknesses Da to Dc are the same, the stress due to shrinkage of each of the dielectric layers 22a to 22c can be dispersed. This suppresses the occurrence of cracks in the multilayer body 2, thereby further improving the reliability of the multilayer ceramic capacitor 1. The average grain size of the ceramic grains contained in the dielectric layer 22c may be smaller than the average grain size of the ceramic grains 220a and 220b contained in the other dielectric layers 22a and 22b. In this case, as described above, the flatness and insulating characteristics of the dielectric layer 22c can be improved compared to when the average grain size of the ceramic grains in the dielectric layers 22a to 22c is the same.

Furthermore, like the dielectric layers 22a and 22b, the dielectric layer 22c also contains at least one type of rare earth element that functions as a donor element. The concentration of the rare earth element with respect to the ceramic that is the main component of the dielectric layer 22c is higher than the concentration of the rare earth element with respect to the ceramic that is the main component of the dielectric layers 22a and 22b. Therefore, the amount of oxygen vacancies generated and the amount of movement are suppressed in the thin dielectric layer 22c compared to the thick dielectric layers 22a and 22b. Therefore, compared to the case where the rare earth element concentration of each of the dielectric layers 22a to 22c is the same, the insulating characteristics of the multilayer ceramic capacitor 1 can be appropriately improved according to the average thickness of the dielectric layers 22a to 22c.

### Manufacturing Process of Multilayer Ceramic Capacitor

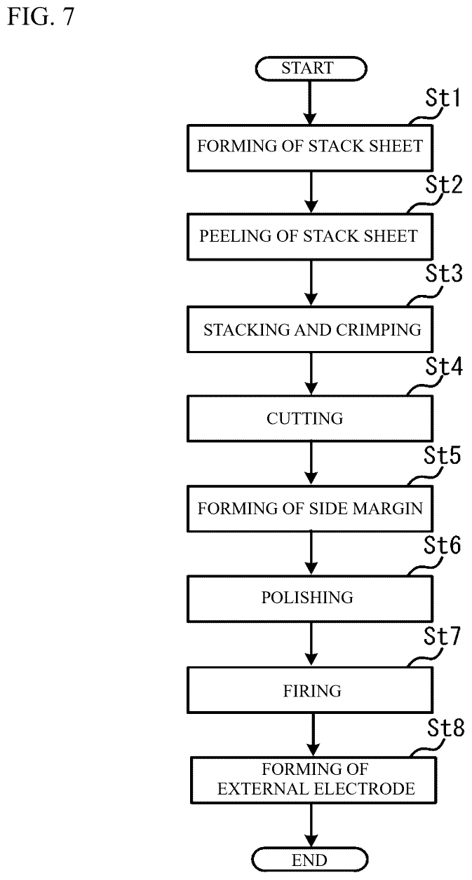

FIG. 7 is a flow chart illustrating an example of the manufacturing process of the multilayer ceramic capacitor 1. This manufacturing process is an example of the manufacturing method of a multilayer ceramic electronic device.

### Stack Sheet Forming Step

First, the stack sheet forming step St1 is performed. In this step, two layers of green sheets that will become the dielectric layers 22a and 22b after the firing step are formed, and internal electrode patterns that will become the internal electrode layers 23a and 23b after the firing step are formed on the two layers of green sheets.

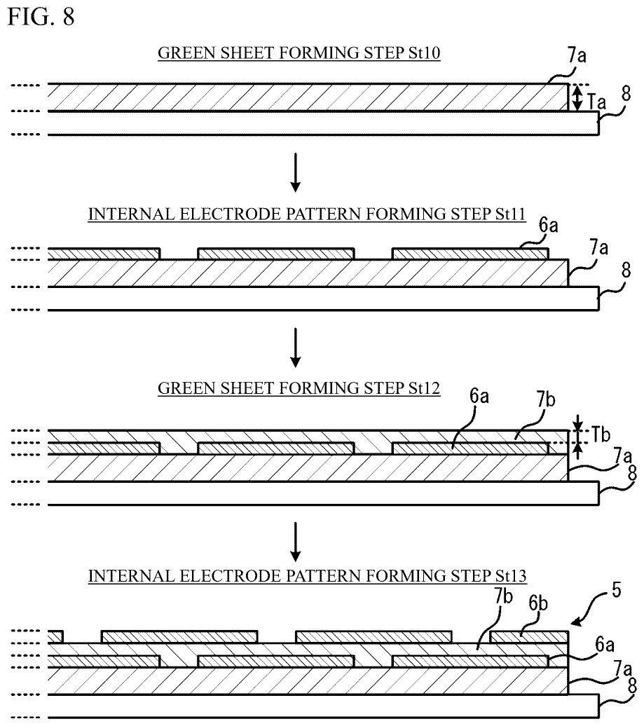

FIG. 8 is a cross-sectional view illustrating an example of the stack sheet forming step St1. FIG. 8 illustrates a cross section along the stacking direction and the length direction of the multilayer body 2 after firing.

First, the green sheet forming step St10 is performed. In the green sheet forming step St10, a green sheet 7a is formed by applying a ceramic slurry onto a base material 8. The ceramic slurry is obtained by adding various additive compounds (such as sintering aids) to ceramic powder, for example, to a dielectric material, and then wet mixing the dielectric material with a binder such as polyvinyl butyral (PVB) resin, an organic solvent such as ethanol or toluene, and a plasticizer. The ceramic slurry is used to apply the green sheet 7a onto the base material 8 by, for example, a die coater method or a doctor blade method, and then dried. The base material 8 is, for example, a PET (polyethylene terephthalate) film.

The additive compound for the ceramic powder is such as an oxide of Mg (magnesium), Mn (manganese), V (vanadium), Cr (chromium), rare earth elements (Y (yttrium), Sm (samarium), Eu (europium), Gd (gadolinium), Tb (terbium), Dy (dysprosium), Ho (holmium), Er (erbium), Tm (thulium) or Yb (ytterbium)), as well as an oxide or glass of Co (cobalt), Ni, Li (lithium), B (boron), Na (sodium), K (potassium) or Si (silicon).

Next, the internal electrode pattern forming step St11 is performed. In the internal electrode pattern forming step St11, an internal electrode pattern 6a is formed by applying a conductive paste to which ceramic particles have been added onto the green sheets 7a. The internal electrode pattern 6a becomes the internal electrode layer 23a after firing.

In the internal electrode pattern forming step St11, a metal conductive paste for forming the internal electrodes containing an organic binder is printed on the green sheet 7a by gravure printing or the like to form a film of multiple internal electrode patterns 6a spaced apart from one another. Ceramic particles are added to the conductive paste as a co-material. The main component of the ceramic particles is not particularly limited, but is preferably the same as the main component ceramic of the dielectric layers 22a and 22b. In addition, the internal electrode pattern 6a is not limited to being printed, and may be formed by a vacuum deposition method such as sputtering.

Next, the green sheet forming step St12 is performed. In the green sheet forming step St12, a ceramic slurry similar to the ceramic slurry used in the green sheet forming step St10 is applied onto the green sheet 7a and the internal electrode pattern 6a to form a green sheet 7b. At this time, for example, the amount of ceramic slurry applied is adjusted so that the green sheet 7b has an average thickness different from that of the green sheet 7a. Specifically, the average thickness Tb of the green sheet 7b is smaller than the average thickness Ta of the green sheet 7a.

The average particle size of the ceramic powder contained in the ceramic slurry used to form the green sheet 7a having a large average thickness Ta is larger than the average particle size of the ceramic powder contained in the ceramic slurry used to form the green sheet 7b having a small average thickness Tb. This allows the average particle size of the ceramic particles in the dielectric layer 22a to be larger than the average particle size of the ceramic particles in the dielectric layer 22b. The green sheet 7a is an example of the first green sheet, and the green sheet 7b is an example of the second green sheet.

The additive compounds of the ceramic slurry used in the green sheet forming steps St10 and St12 may contain at least one rare earth element that functions as a donor element for the main ceramic component, as described above. The rare earth element added to the ceramic slurry is such as Y (yttrium), Sm (samarium), Eu (europium), Gd (gadolinium), Tb (terbium), Dy (dysprosium), Ho (holmium), Er (erbium), Tm (thulium), or Yb (ytterbium). Other added compounds are such as Mg (magnesium), Mn (manganese), V (vanadium), Cr (chromium), and oxides or glasses of Co (cobalt), Ni, Li (lithium), B (boron), Na (sodium), K (potassium), or Si (silicon).

When a rare earth element is added to the ceramic slurry, in the green sheet forming step St12, the ceramic slurry is adjusted so that the concentration of the rare earth element with respect to the ceramic that is the main component of the green sheet 7b is higher than the concentration of the rare earth element with respect to the ceramic that is the main component of the green sheet 7a. As a result, the concentration of the rare earth element contained in the dielectric layer 22b is higher than the concentration of the rare earth element contained in the dielectric layer 22a.

Next, the internal electrode pattern forming step St13 is performed. In the internal electrode pattern forming step St13, similar to the internal electrode pattern forming step St11, an internal electrode pattern 6b is formed by applying a conductive paste to which ceramic particles have been added onto the green sheet 7b. The internal electrode pattern 6b becomes the internal electrode layer 23b after firing. The internal electrode patterns 6a and 6b are formed so as to be shifted from each other by half a pitch in the length direction. The internal electrode pattern 6b may be formed by a vacuum deposition method such as sputtering. Moreover, the internal electrode pattern 6a is an example of a first electrode pattern, and the internal electrode pattern 6b is an example of a second electrode pattern.

By the above steps, a plurality of stack sheets 5 are formed. After that, the stack sheet peeling step St2 and the stacking and crimping step St3 are performed.

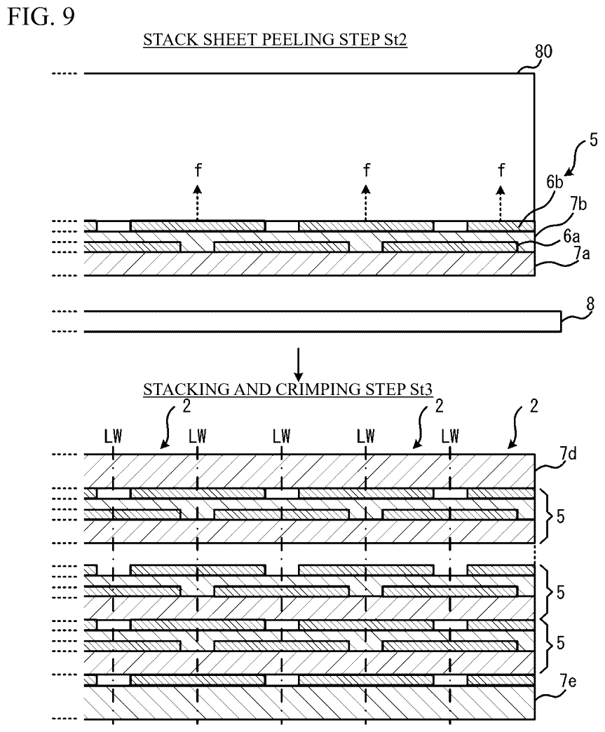

FIG. 9 is a cross-sectional view illustrating an example of the stack sheet peeling step St2 and the stacking and crimping step St3. FIG. 9 illustrates a cross-section along the stacking direction and length direction of the multilayer body 2 after firing.

### Laminated Sheet Peeling Step

After the stack sheet forming step St1, the stack sheet peeling step St2 is performed. In the stack sheet peeling step St2, the stack sheet 5 on which the green sheets 7a and 7b are stacked is peeled off from the base material 8. At this time, the peeling device 80 applies an adsorption force f to the stack sheet 5 from above and lifts the stack sheet upward. As a result, the stack sheet 5 is peeled off from the base material 8. The base material 8 is fixed to a conveying table (not illustrated) or the like.

In this way, in the stack sheet peeling step St2, the green sheets 7a and 7b stacked on top of each other are peeled off from the base material 8 together. Therefore, even if the average thicknesses Ta and Tb of the green sheets 7a and 7b are reduced, the strength of the stack sheet 5 is higher than that of the individual green sheets 7a and 7b, so the risk of damage is reduced. Therefore, it is possible to easily manufacture the multilayer ceramic capacitor 1 with the thin dielectric layers 22a and 22b.

### Stacking and Crimping Step

Next, the stacking and crimping step St3 is performed. In the stacking and crimping step St3, multiple sets of the green sheets 7a and 7b are stacked and crimped. In other words, the multiple stack sheets 5 are stacked and crimped. At this time, the multiple stack sheets 5 are sandwiched from above and below in the stacking direction by other green sheets 7d and 7e that will become the cover layers 20 and 21 after firing, and crimping is performed. On the surface of the lowest green sheet 7e, the internal electrode pattern 6b is formed by the same method as in the internal electrode pattern forming step St13. The crimping means may be, for example, a hydrostatic press, but is not limited to this.

### Cutting Step

Next, the cutting step St4 is performed. In the cutting step St4, the crimped green sheets 7a, 7b, 7d, and 7e are cut along a plurality of cut lines LW extending in two orthogonal directions at regular intervals, for example, by a blade. As a result, the plurality of stack sheets 5 are divided into a plurality of pre-fired multilayer bodies 2. In FIG. 9, the cut lines LW are illustrated along the width direction of the multilayer body 2. The ends of the internal electrode patterns 6a and 6b are exposed on the end faces 2A and 2B, which are the cut surfaces of the multilayer body 2. Although not illustrated, when the plurality of stack sheets 5 are cut along the cut lines along the length direction of the multilayer body 2, the ends of the internal electrode patterns 6a and 6b are exposed on the side faces 2E and 2F, which are the cut surfaces of the multilayer body 2.

### Side Margin Forming Step

Next, the side margin forming step St5 is performed. In the side margin forming step St5, the side faces 2E and 2F of the multilayer body 2 are pressed against the green sheet for the side margins, and then the multilayer body 2 is moved away from the green sheet for the side margins. At this time, the parts of the green sheet remaining on the side faces 2E and 2F of the multilayer body 2 become the side margins 40 and 41. As a result, the side margins 40 and 41 are formed on the side faces 2E and 2F of the multilayer body 2 before firing.

### Polishing Step

Next, the polishing step St6 is performed. In the polishing step St6, the multilayer body 2 is polished by a method such as barrel polishing. As a result, the corners of the multilayer body 2 are rounded to form the edge portions 200 and 210.

### Firing Step

Next, the firing step St7 is performed. In the firing step St7, the multilayer body 2 before firing is subjected to a binder removal step in an N₂ atmosphere at 250 to 500° C., and then fired for about 1 hour at a firing temperature of 1200° C. or higher in a reducing atmosphere with an oxygen partial pressure of 0.003 (Pa), sintering each particle in the multilayer body 2. As a result, in the multilayer body 2, the green sheets 7a, 7b, 7d, and 7e become the dielectric layers 22a and 22b and the cover layers 20 and 21, and the internal electrode patterns 6a and 6b become the internal electrode layers 23a and 23b. In the side margin formation step St5, the parts of the green sheets remaining on the side faces 2E and 2F of the multilayer body 2 become the side margins 40 and 41.

Since the green sheets 7a and 7b have different average thicknesses Ta and Tb, differences occur in the sintering properties of the dielectric layers 22a and 22b in the firing step St7 as described above, and for example, the amount of shrinkage and the timing of shrinkage of the dielectric layers 22a and 22b differ. This reduces the difference in the amount of shrinkage between the side margins 40 and 41 and the multilayer body 2, and compared to when the average thicknesses Ta and Tb are the same, it is possible to disperse the stress caused by the shrinkage of the dielectric layers 22a and 22b. This suppresses the occurrence of cracks in the multilayer body 2, improving the reliability of the multilayer ceramic capacitor 1.

Furthermore, in the firing step St7, in the section of the end margins 22m, the ceramic particles of the green sheets 7a and the ceramic particles of the green sheets 7b grow together, resulting in the distribution of ceramic grains 220m with a grain size different from that of the dielectric layers 22a and 22b.

In the firing step St7, the raw material powder is exposed to a reducing atmosphere, so oxygen vacancies are generated in the main ceramic component. Here, if a rare earth element is contained in the green sheets 7a and 7b as described above, the concentration of the rare earth element with respect to the main ceramic component of the green sheet 7b is higher than the concentration of the rare earth element with respect to the main ceramic component of the green sheet 7a, so the amount of oxygen vacancies generated and the amount of movement in the main ceramic component are appropriately suppressed according to the average thickness of the dielectric layers 22a and 22b, and the insulating characteristics are improved.

### External Electrode Formation Step

Next, the external electrode formation step St8 is performed. In the external electrode formation step St8, a conductive paste containing, for example, metal powder, glass frit, binder, and solvent is applied to each of the end faces 2A and 2B, the upper face 2C, the lower face 2D, and each of the side faces 2E and 2F of the multilayer body 2. After the conductive paste is applied, the conductive paste is dried to form the external electrodes 3a and 3b. The binder and the solvent evaporate as a result of baking. Examples of methods for applying the conductive paste is such as sputtering or dipping. In this manner, the multilayer ceramic capacitor 1 is manufactured.

### Manufacturing Process of Other Multilayer Ceramic Capacitors)

Next, the manufacturing of another multilayer ceramic capacitor 1a will be described. Here, only the differences between the stack sheet formation step St1 and the manufacturing of the multilayer ceramic capacitor 1 will be described.

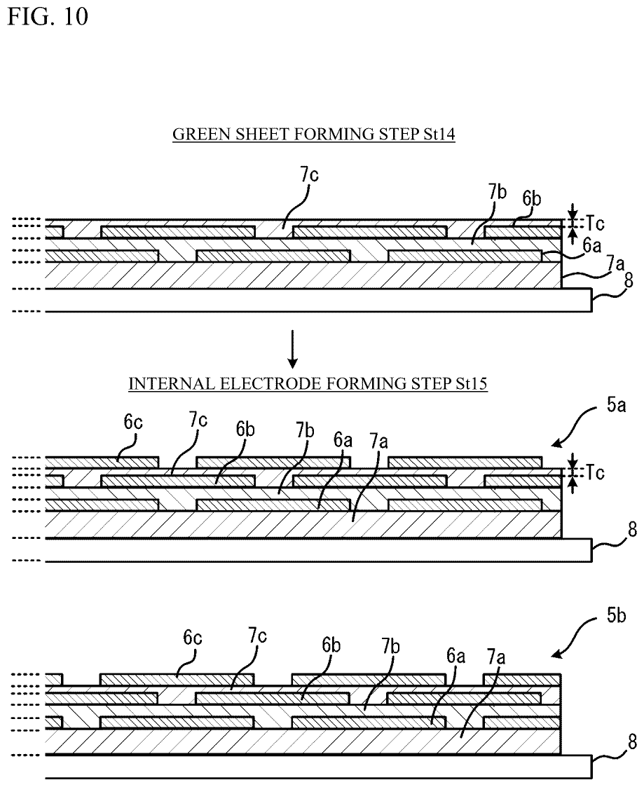

FIG. 10 is a cross-sectional view illustrating an example of the green sheet forming step St14 and the internal electrode pattern forming step St15 of the multilayer ceramic capacitor 1a. FIG. 10 illustrates a cross section along the stacking direction and the length direction of the multilayer body 2 after firing.

After the above-mentioned internal electrode pattern forming step St13, the green sheet forming step St14 is performed. In the green sheet forming step St14, a ceramic slurry similar to the ceramic slurry used in the green sheet forming step St10 is applied onto the green sheet 7band the internal electrode pattern 6b to form a green sheet 7c. The green sheet 7c becomes the dielectric layer 22c after firing. The green sheet 7c is an example of a third green sheet.

The amount of ceramic slurry applied is adjusted, for example, so that the average thickness Tc of the green sheet 7c is different from the average thicknesses Ta and Tb of the green sheets 7a and 7b. Specifically, the average thickness Tc of the green sheet 7c is smaller than the average thicknesses Ta and Tb of the green sheets 7a and 7b. The average particle size of the ceramic powder contained in the ceramic slurry used to form the green sheet 7c may be smaller than the average particle size of the ceramic powder contained in the ceramic slurry used to form the green sheets 7a and 7b. This allows the average particle size of the ceramic particles in the dielectric layer 22c to be smaller than the average particle size of the ceramic particles in the dielectric layers 22a and 22b.

The ceramic slurry used in the green sheet forming step St14 may also contain at least one type of rare earth element that functions as a donor element for the main component ceramic. At this time, the ceramic slurry is adjusted so that the concentration of the rare earth element with respect to the main component ceramic of the green sheet 7c is higher than the concentration of the rare earth element with respect to the main component ceramic of the green sheets 7a and 7b. This makes the concentration of the rare earth element contained in the dielectric layer 22c higher than the concentration of the rare earth element contained in the dielectric layers 22a and 22b.

Next, the internal electrode pattern forming step St15 is performed. In the internal electrode pattern forming step St15, similar to the internal electrode pattern forming step St11, an internal electrode pattern 6c is formed by applying a conductive paste to which ceramic particles are added onto each of the green sheets 7c. The internal electrode pattern 6c becomes the internal electrode layer 23a after firing. The internal electrode pattern 6c is formed so as to be shifted by half a pitch from the internal electrode pattern 6b in the length direction. The internal electrode pattern 6c may be formed by a vacuum deposition method such as sputtering. The internal electrode pattern 6c is also an example of a third electrode pattern.

A stack sheet 5a is thus formed. The stack sheet 5b, which is formed by stacking the green sheets 7a to 7c, in which the internal electrode patterns 6a to 6c are shifted by half a pitch from the stack sheet 5a, is also formed by the same method as above. In the subsequent stack sheet peeling step St2, the stack sheets 5a and 5b on which the green sheets 7a to 7c are stacked are peeled off from the base material 8 by the above-mentioned method. Thereafter, the stacking and crimping step St3 is carried out.

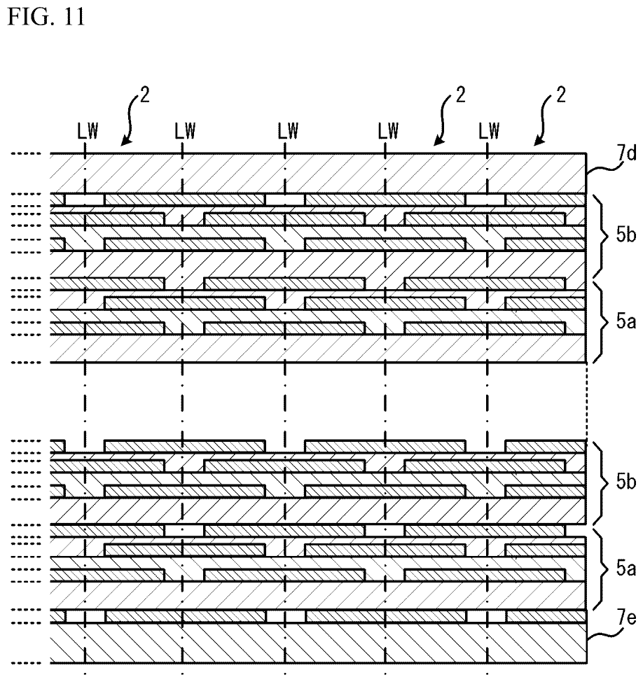

FIG. 11 is a cross-sectional view illustrating an example of the stacking and crimping step St3 in the embodiment. FIG. 11 illustrates a cross-section along the stacking direction and length direction of the multilayer body 2 after firing. In FIG. 11, the same components as in FIG. 9 are given the same reference numerals, and their description is omitted.

In the stacking and crimping step St3, a plurality of sets of the green sheets 7a to 7c are stacked and crimped by the above-mentioned method. Specifically, the stack sheets 5a and 5b are alternately stacked and crimped. As a result, the green sheets 7a to 7c are repeatedly stacked in the stacking direction through the internal electrode patterns 6a to 6c.

In the subsequent cutting step St4, the crimped green sheets 7a to 7d are cut along a plurality of cut lines extending in two orthogonal directions at regular intervals, for example, by a blade. As a result, the plurality of stack sheets 5a and 5b are divided into the plurality of pre-fired multilayer bodies 2. The ends of the internal electrode patterns 6a to 6c are exposed on the cut surface of the multilayer body 2. Next, in the side margin forming step St5, the side margins 40 and 41 are formed by attaching a part of the green sheet to the widthwise side faces of the multilayer body 2. Next, in the polishing step St6, the multilayer body 2 is polished by a method such as barrel polishing.

Then, in the firing step St7, the multilayer body 2 is fired by the same method as above. Since the average thicknesses Ta to Tc of the green sheets 7a to 7c are different from each other, in the firing step St7, differences occur in the sintering properties of the dielectric layers 22a to 22c as described above, and for example, the shrinkage amount and shrinkage timing of the dielectric layers 22a to 22c differ. Therefore, the difference in the shrinkage amount between the side margins 40 and 41 and the multilayer body 2 is reduced, and compared to the case where the average thicknesses Ta to Tc are the same, the stress due to the shrinkage of the dielectric layers 22a to 22c can be dispersed. This suppresses the occurrence of cracks in the multilayer body 2, improving the reliability of the multilayer ceramic capacitor 1a.

Thereafter, in the external electrode formation step St8, the external electrodes 3a and 3b are respectively formed on the end faces 2A and 2B of the multilayer body 2. In this manner, the multilayer ceramic capacitor 1a is manufactured.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
a multilayer body having a rectangular parallelepiped shape in which a plurality of first dielectric layers, a plurality of second dielectric layers, and a plurality of internal electrode layers are stacked,
wherein each average thickness of each of the plurality of first dielectric layers is different from that of each of the plurality of second dielectric layers, and
wherein each of the plurality of first dielectric layers and each of the plurality of second dielectric layers are alternately stacked through each of the plurality of internal electrode layers.

2. The multilayer ceramic electronic device as claimed in claim 1,
wherein each average thickness of each of the plurality of first dielectric layers is 1.05 times to 2.0 times as each average thickness of each of the plurality of second dielectric layers.

3. The multilayer ceramic electronic device as claimed in claim 1,
wherein each average thickness of each of the plurality of first dielectric layers is 0.4 μm or more and 0.8 μm or less, and
wherein each average thickness of each of the plurality of second dielectric layers is 0.3 μm or more and 0.7 μm or less.

4. The multilayer ceramic electronic device as claimed in claim 1,
wherein each average thickness of each of the plurality of second dielectric layers is smaller than each average thickness of each of the plurality of first dielectric layers,
wherein each of the plurality of first dielectric layers and each of the plurality of second dielectric layers include at least one type rare earth element, and
wherein a concentration of the at least one type rare earth element of each of the plurality of second dielectric layers with respect to a main component ceramic of each of the plurality of second dielectric layers is higher than that of the at least one type rare earth element of each of the plurality of first dielectric layers with respect to a main component ceramic of each of the plurality of first dielectric layers.

5. The multilayer ceramic electronic device as claimed in claim 4,
wherein the concentration of the at least one type rare earth element of each of the plurality of second dielectric layers with respect to the main component ceramic of each of the plurality of second dielectric layers is 1.08 times or more as the concentration of the at least one type rare earth element of each of the plurality of first dielectric layers with respect to a main component ceramic of each of the plurality of first dielectric layers.

6. The multilayer ceramic electronic device as claimed in claim 5,
wherein the concentration of the at least one type rare earth element of each of the plurality of second dielectric layers with respect to the main component ceramic of each of the plurality of second dielectric layers is 1.7 times or less as the concentration of the at least one type rare earth element of each of the plurality of first dielectric layers with respect to a main component ceramic of each of the plurality of first dielectric layers.

7. The multilayer ceramic electronic device as claimed in claim 4,
wherein each of the plurality of first dielectric layers and each of the plurality of second dielectric layers include magnesium and manganese, and
wherein a total concentration of the at least one type rare earth element, the magnesium and the manganese of each of the plurality of second dielectric layers with respect to the main component ceramic of each of the plurality of second dielectric layers is 1.05 times or more as the concentration of the at least one type rare earth element, the magnesium and the manganese of each of the plurality of first dielectric layers with respect to the main component ceramic of each of the plurality of first dielectric layers.

8. The multilayer ceramic electronic device as claimed in claim 7, wherein the total concentration of the at least one type rare earth element, the magnesium and the manganese of each of the plurality of second dielectric layers with respect to the main component ceramic of each of the plurality of second dielectric layers is 1.5 times or less as the concentration of the at least one type rare earth element, the magnesium and the manganese of each of the plurality of first dielectric layers with respect to the main component ceramic of each of the plurality of first dielectric layers.

9. The multilayer ceramic electronic device as claimed in claim 1,
wherein each average thickness of each of the plurality of second dielectric layers is smaller than each average thickness of each of the plurality of first dielectric layers, and
wherein each average grain size of ceramic grains of each of the plurality of first dielectric layers is larger than each average grain size of ceramic grains of each of the plurality of second dielectric layers.

10. The multilayer ceramic electronic device as claimed in claim 9,
wherein each average grain size of the ceramic grains of each of the plurality of first dielectric layers is 1.15 times to 2.0 times as each average grain size of ceramic grains of each of the plurality of second dielectric layers.

11. The multilayer ceramic electronic device as claimed in claim 9,
wherein each average grain size of the ceramic grains of each of the plurality of first dielectric layers is 80 nm or more and 350 nm or less, and
wherein each average grain size of the ceramic grains of each of the plurality of second dielectric layers is 70 nm or more and 300 nm or less.

12. The multilayer ceramic electronic device as claimed in claim 11,
wherein each of the plurality of internal electrode layers is alternately drawn out to a pair of end faces of the multilayer body facing each other in a direction orthogonal to a stacking direction,
wherein the multilayer body includes an end margin next to one set of the plurality of internal electrode layers drawn out to one of the pair of end faces in the direction orthogonal to the stacking direction, and
wherein an average grain size of ceramic grains in the end margin is 75 nm or more and 330 nm or less.

13. The multilayer ceramic electronic device as claimed in claim 1,
wherein in the multilayer body, a plurality of third dielectric layers each having an average thickness different from each average thickness of each of the plurality of first dielectric layers and each average thickness of each of the plurality of second dielectric layers are stacked, and
wherein each of the plurality of third dielectric layers is sandwiched between each of the plurality of first dielectric layers and each of the plurality of second dielectric layers with each of the plurality of internal electrode layers therebetween.

14. The multilayer ceramic electronic device as claimed in claim 13,
wherein each average thickness of each of the plurality of second dielectric layers is smaller than each average thickness of each of the plurality of first dielectric layers,
wherein each average thickness of each of the plurality of third dielectric layers is smaller than each average thickness of each of the plurality of second dielectric layers,
wherein each of the plurality of first dielectric layers, each of the plurality of second dielectric layers, and each of the plurality of third dielectric layers include at least one type rare earth element,
wherein a concentration of the at least one type rare earth element of each of the plurality of second dielectric layers with respect to a main component ceramic of each of the plurality of second dielectric layers is higher than a concentration of the at least one type rare earth element of each of the plurality of first dielectric layers with respect to a main component ceramic of each of the plurality of first dielectric layers, and
wherein a concentration of the at least one type rare earth element of each of the plurality of third dielectric layers with respect to a main component ceramic of each of the plurality of third dielectric layers is higher than a concentration of the at least one type rare earth element of each of the plurality of second dielectric layers with respect to a main component ceramic of each of the plurality of second dielectric layers.

15. A manufacturing method of a multilayer ceramic electronic device comprising:
forming each of a plurality of first green sheets by applying a ceramic slurry on each of base materials;
forming each of a plurality of first internal electrode patterns on each of the first green sheets;
forming each of a plurality of second green sheets by applying a ceramic slurry on each of the plurality of first green sheets and each of the plurality of first internal electrode patterns so that each average thickness of each of the plurality of second green sheets is different from each average thickness of each of the plurality of first green sheets;
forming each of a plurality of second internal electrode patterns on each of the plurality of second green sheets;
peeling the plurality of first green sheets and the plurality of second green sheets from the base materials;
stacking and crimping a plurality of sets of the plurality of first green sheets and the plurality of second green sheets;
dividing the plurality of sets of the plurality of first green sheets and the plurality of second green sheets after the crimping into a plurality of multilayer bodies by cutting the plurality of sets of the plurality of first green sheets and the plurality of second green sheets along a stacking direction; and
firing the plurality of multilayer bodies.

16. The method as claimed in claim 15,
wherein an average particle size of ceramic powder contained in the ceramic slurry used to form the green sheet having a larger average thickness out of the plurality of first green sheets and the plurality of second green sheets is larger than the average particle size of the ceramic powder contained in the ceramic slurry used to form the green sheet having a smaller average thickness.

17. The method as claimed in claim 15,
wherein, in the forming of the plurality of first green sheets, the ceramic slurry to which at least one type rare earth element is added is applied onto the base materials, and
wherein, in the forming of the plurality of second green sheets, the ceramic slurry to which the at least one type rare earth element is added is applied onto the plurality of first green sheets and the plurality of first internal electrode patterns so that each average thickness of the ceramic slurry is smaller than that of the plurality of first green sheet, and the ceramic slurry is adjusted so that a concentration of the at least one type rare earth element in a main component ceramic of the plurality of second green sheets is higher than the concentration of the at least one type rare earth element in the main component ceramic of the plurality of first green sheets.

18. A manufacturing method of a multilayer ceramic electronic device comprising:
forming each of a plurality of first green sheets by applying a ceramic slurry on each of base materials;
forming each of a plurality of first internal electrode patterns on each of the first green sheets;
forming each of a plurality of second green sheets by applying a ceramic slurry on each of the plurality of first green sheets and each of the plurality of first internal electrode patterns so that each average thickness of each of the plurality of second green sheets is different from each average thickness of each of the plurality of first green sheets;
forming each of a plurality of second internal electrode patterns on each of the plurality of second green sheets;
forming each of a plurality of third green sheets by applying a ceramic slurry on each of the plurality of second green sheets and each of the plurality of second internal electrode patterns so that each average thickness of each of the plurality of third green sheets is different from each average thickness of each of the plurality of first green sheets and each average thickness of each of the plurality of second green sheets;
forming each of a plurality of third internal electrode patterns on each of the plurality of third green sheets;
peeling the plurality of first green sheets, the plurality of second green sheets and the plurality of third green sheets from the base materials;
stacking and crimping a plurality of sets of the plurality of first green sheets, the plurality of second green sheets and the plurality of third green sheets;
dividing the plurality of sets of the plurality of first green sheets, the plurality of second green sheets and the plurality of third green sheets after the crimping into a plurality of multilayer bodies by cutting the plurality of sets of the plurality of first green sheets, the plurality of second green sheets and the plurality of third green sheets along a stacking direction; and
firing the plurality of multilayer bodies.

19. The method as claimed in claim 18,
wherein, in the forming of the plurality of first green sheets, the forming of the plurality of second green sheets and the forming of the plurality of third green sheets, at least one type rare earth element is added to the ceramic slurry, and
wherein, in the forming of the plurality of second green sheets, the ceramic slurry is adjusted so that a concentration of the at least one type rare earth element in a main component ceramic of the plurality of second green sheets is higher than the concentration of the at least one type rare earth element in the main component ceramic of the plurality of first green sheets, and
wherein, in the forming of the plurality of third green sheets, the ceramic slurry is adjusted so that a concentration of the at least one type rare earth element in a main component ceramic of the plurality of third green sheets is higher than the concentration of the at least one type rare earth element in the main component ceramic of the plurality of second green sheets.
